(19) United States
(12) Patent Application Publication
(10) Pub. No.: US 2017/0139188 A1
(43) Pub. Date: May 18, 2017

(54) Far Infrared Imaging Lens Set, Objective Lens And Fire Source Detector

(71) Applicant: HAN'S LASER TECHNOLOGY INDUSTRY GROUP CO., LTD., Shenzhen (CN)

(72) Inventors: Jiaying LI, Shenzhen (CN); Chaoming ZHOU, Shenzhen (CN); Bo SUN, Shenzhen (CN); Hai HUANG, Shenzhen (CN); Yuqing CHEN, Shenzhen (CN); Yunfeng GAO, Shenzhen (CN)

(73) Assignee: HAN'S LASER TECHNOLOGY INDUSTRY GROUP CO., LTD., Shenzhen (CN)

(21) Appl. No.: 15/322,557

(22) PCT Filed: Aug. 7, 2014
(86) PCT No.: PCT/CN2014/083851

§ 371 Date: Dec. 28, 2016

(51) Int. Cl. G02B 13/14; G02B 1/02; G02B 9/16; G01J 5/08; G01J 5/00

(52) U.S. Cl. CPC G02B 13/14; G01J 5/0806; G01J 5/0018; G02B 9/16; G02B 1/02; G01J 2005/0077

(57) ABSTRACT

An objective lens employing said far infrared imaging lens set (10), and a fire source detector employing said objective lens, the infrared imaging lens set (10) comprising a first lens (100), a second lens (200), and a third lens (300) successively arranged along a principal axis: the first lens (100) has a first curved surface (102) and a second curved surface (104), the radius of curvature of said first curved surface (102) being 57×(1±5%) mm, and the radius of curvature of said second curved surface (104) being 85×(1±5%) mm; the second lens (200) has a third curved surface (202) and a fourth curved surface (204), the radius of curvature of said third curved surface (202) being 210×(1±5%) mm, and the radius of curvature of said fourth curved surface (204) being 37×(1±5%) mm; and the third lens (300) has a fifth curved surface (302) and a sixth curved surface (304), the radius of curvature of said fifth curved surface (302) being 100×(1±5%) mm, and the radius of curvature of said sixth curved surface (304) being 400×(1±5%) mm; wherein the first curved surface (102), the second curved surface (104), the third curved surface (202), the fourth curved surface (204), the fifth curved surface (302), and the sixth curved surface (304) are successively arranged, and are all convex to the object side.

### FIELD OF THE INVENTION

The present disclosure relates to an optical field, and more particular relates to a far infrared imaging lens assembly, a far infrared imaging objective lens and a fire source detector of a fire hazard.

### BACKGROUND OF THE INVENTION

When a fire hazard occurs, it is difficult to determine a fire source location due to the different fire-leading materials, especially, various materials may throw off a lot of smoke, it is difficult for a firefighter to approach and it obscures a vision, thus the fire source is difficult to be found, so that it is difficult to start the fire-fighting measures. How to find the fire source through the dense smoke becomes very important.

The light ray of the fire source is a far infrared ray having a long wavelength, it has a strong and long penetrating power, the fire source can be found by detecting the far infrared ray

### SUMMARY

Therefore, it is necessary to provide a lens assembly which can gather far infrared ray.

Further, a far infrared imaging objective lens and a fire source detector of a fire hazard are provided.

A far infrared imaging lens assembly, includes: a first lens, a second lens, and a third lens successively arranged along a principal axis, wherein the first lens includes a first curved surface and a second curved surface, a radius of curvature of the first curved surface is 57×(1±5%) millimeters, and a radius of curvature of the second curved surface is 85×(1±5%) millimeters; the second lens includes a third curved surface and a fourth curved surface, a radius of curvature of the third curved surface is 210×(1±5%) millimeters, and a radius of curvature of the fourth curved surface is 37×(1±5%) millimeters; the third lens includes a fifth curved surface and a sixth curved surface, a radius of curvature of the fifth curved surface is 100×(1±5%) millimeters, and a radius of curvature of the sixth curved surface is 400×(1±5%) mm; the first curved surface, the second curved surface, the third curved surface, the fourth curved surface, the fifth curved surface, and the sixth curved surface are successively arranged, and all convex to the object side.

According to an embodiment, a distance between the second curved surface and the third curved surface is 15 millimeters, and a distance between the fourth curved surface and the fifth curved surface is 30 millimeters.

According to an embodiment, a central thickness of the first lens is 5×(1±5%) millimeters.

According to an embodiment, a central thickness of the second lens is 2×(1±5%) millimeters

According to an embodiment, a central thickness of the third lens is 3×(1±5%) millimeters

According to an embodiment, the first lens is made of Ge.

According to an embodiment, the second lens is made of ZnSe.

According to an embodiment, the third lens is made of Ge.

A far infrared objective lens, includes a lens barrel and a lens assembly mentioned above, wherein the lens barrel is configured to receive the lens assembly.

A fire source detector of a fire hazard, includes a far infrared imaging objective lens mentioned above and a thermo-sensitive receiver, wherein the thermo-sensitive receiver is located on a focal point of the objective lens.

In the forgoing fire source detector of a fire hazard, the objective lens and the lens assembly thereof, a distal target can be detected by detecting the far infrared light in the environments such as night and heavy fog, particularly, the fire source location can be found in a heavy smoke environment, it can extensively applied to detect in the occasions such as fight fighting, monitoring, and high voltage power line

### BRIEF DESCRIPTION OF THE DRAWINGS

FIG. 1 is a side view of a lens assembly according to an embodiment;

FIG. 2 is a graphic diagram showing transfer function of an objective lens according to the lens assembly of FIG. 1;

FIG. 3 is a graphic diagram showing a narrow beam of an objective lens according to the lens assembly of FIG. 1; and

FIG. 4 is a graphic diagram showing a broad beam of an objective lens according to the lens assembly of FIG. 1.

### DETAILED DESCRIPTION OF THE EMBODIMENTS

FIG. 1 shows a side view of a far infrared imaging lens assembly according to an embodiment, illustrating an arrangement. The far infrared imaging lens assembly 10 includes a first lens 100, a second lens 200, and a third lens 300 successively arranged along a principal axis. The first lens 100 is a meniscus positive lens, the second lens 200 is a meniscus negative lens 200, the third lens 300 is a meniscus positive lens. The principal axis of the lens is an axis that extends through a centre of the lens and is perpendicular to the lens. The principal axes of the first lens 100, the second lens 200, and the third lens 300 are coaxial with each other.

The lens assembly of the illustrated embodiment is mainly used for detecting a far infrared light, more particularly, detecting the far infrared light having a wavelength of 10640 nanometers. For example, the light ray emitted from the fire source of a fire hazard. The left side in FIG. 1 is the object side, the right side is the image side. The light ray of the far infrared light source comes from the object side, and images clearly on the focal plane of the image side of the lens assembly.

Specifically, the first lens 100 includes a first curved surface 102 and a second curved surface 104, the first curved surface 102 is convex to the object side, the second curved surface 104 is concaved inwardly relative to the first curved surface 102 (i.e., the second curved surface 104 is convex to the object side). A radius of curvature of the first curved surface 102 is 57×(1±5%) millimeters, and a radius of curvature of the second curved surface 104 is 85×(1±5%) millimeters. A central thickness of the first lens 100 (i.e. a thickness of the first lens 100 along the principal axis) is 5×(1±5%) millimeters. The first lens 100 can be manufactured by material of Ge.

The second lens 200 includes a third curved surface 202 and a fourth curved surface 204. The third curved surface 202 is convex to the object side, the fourth curved surface 204 is concaved inwardly relative to the third curved surface 202 (i.e. the fourth curved surface 204 is convex to the object side). A radius of curvature of the third curved surface 202 is 210×(1±5%) millimeters, and a radius of curvature of the fourth curved surface 204 is 37×(1±5%) millimeters. A central thickness of the second lens 200 (i.e. a thickness of the second lens 200 along the principal axis) is 2×(1±5%) millimeters. The second lens 200 can be manufactured by material of ZnSe.

The third lens 300 includes a fifth curved surface 302 and a sixth curved surface 304. The fifth curved surface 302 is convex to the object side, the sixth curved surface 304 is concaved inwardly relative to the fifth curved surface 302 (i.e. the sixth curved surface 304 is convex to the object side). A radius of curvature of the fifth curved surface 302 is 100×(1±5%) millimeters, and a radius of curvature of the sixth curved surface 304 is 400×(1±5%) millimeters. A central thickness of the third lens 300 (i.e. a thickness of the third lens 300 along the principal axis) is 3×(1±5%) millimeters. The third lens 300 can be manufactured by material of Ge.

Further, a distance between the second curved surface 104 and the third curved surface 202 is 15 millimeters. A distance between the fourth curved surface 204 and the fifth curved surface 302 is 30 millimeters.

In a preferred embodiment, the dimensions and the position relationship of the lens are shown as follows. Above dimensions can float within a tolerance range of ±5%.

The lens 100:

A radius of curvature of the curved surface 102 is 57 millimeters;

A radius of curvature of the curved surface 104 is 85 millimeter;

A central thickness is 5 millimeters;

The material is Ge;

The lens 200:

A radius of curvature of the curved surface 202 is 210 millimeters;

A radius of curvature of the curved surface 204 is 37 millimeter;

A central thickness is 2 millimeters;

The material is ZnSe;

The lens 300:

A radius of curvature of the curved surface 302 is 100 millimeters;

A radius of curvature of the curved surface 304 is 400 millimeter;

A central thickness is 3 millimeters;

The material is Ge;

A distance between the curved surface 104 of the lens 100 and the curved surface 202 of the lens 200 is 15 millimeters. A distance between the curved surface 204 of the lens 200 and the curved surface 302 of the lens 300 is 30 millimeters

The light passing wavelength of the lens assembly λ=10640 nm

The overall focal length f′=75 mm;

D/f=1:1.6;

2η(field of view)=25.4 mm

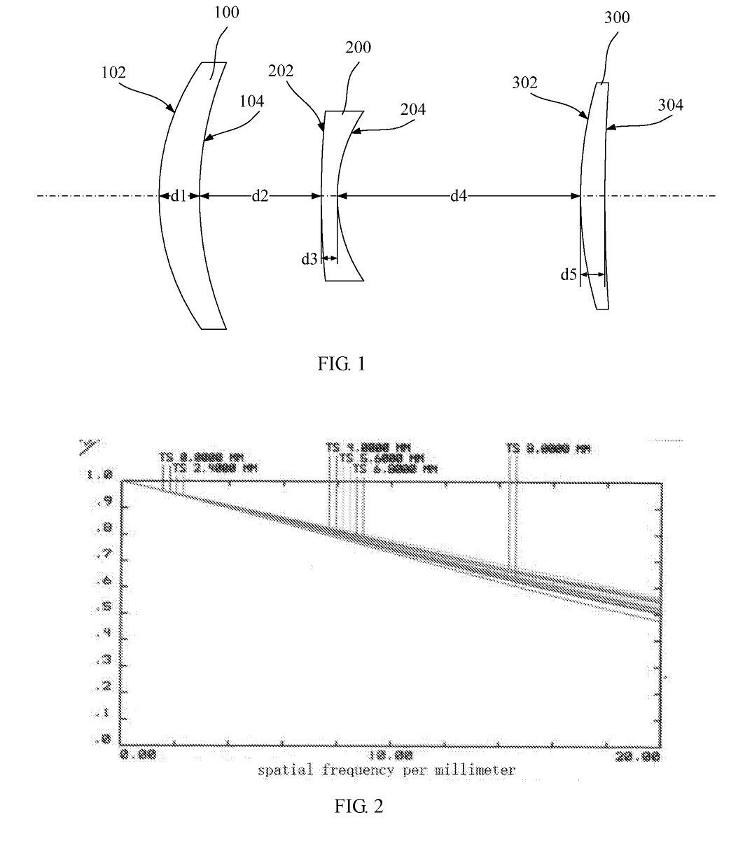

FIG. 2 is a graphic diagram showing transfer function of an objective lens according to the lens assembly, when the resolution reaches 20 line pairs per millimeter, the M.T.F value has reached 0.5, such that the imaging quality is quite ideally.

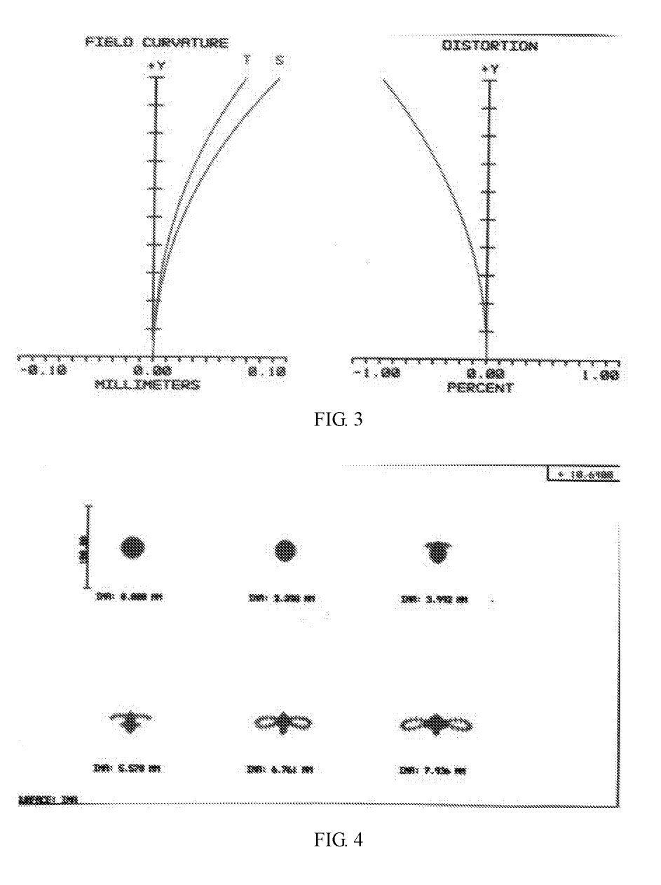

FIG. 3 is a graphic diagram showing a narrow beam of an objective lens according to the lens assembly, not only the astigmatism but also the distortions have reached an ideal level.

FIG. 4 is a graphic diagram showing a broad beam of an objective lens on the whole imaging surface, according to the lens assembly, all the sizes of astigmatisms ranges from 7 to 14 micrometers, it can fully satisfy a requirement of a thermo-sensitive element.

The lens assembly mentioned above is assembled in a lens barrel, a far infrared imaging objective lens can be formed. A total length of the objective lens is 95 millimeters.

The far infrared imaging objective lens mentioned above can be applied to a fire source detection in a fire hazard. On the focal plane of the far infrared imaging objective lens, a thermo-sensitive receiver is located. The thermo-sensitive receiver receives the far infrared light source which is focused by the objective lens, and then a detecting of a fire source of a fire hazard is achieved.

In the fire source detector of a fire hazard mentioned above, and an objective and a lens assembly thereof, a distal target can be detected by detecting the far infrared light in the environments such as night and heavy fog, particularly, the fire source location can be found in a heavy smoke environment, it can be extensively applied to detect in the occasions such as fight fighting, monitoring, and high voltage power line.

The above are several embodiments of the present invention described in detail, and should not be deemed as limitations to the scope of the present invention. It should be noted that variations and improvements will become apparent to those skilled in the art to which the present invention pertains without departing from its spirit and scope. Therefore, the scope of the present invention is defined by the appended claims.

1. A far infrared imaging lens assembly, comprising: a first lens, a second lens, and a third lens successively arranged along a principal axis, wherein,
the first lens comprises a first curved surface and a second curved surface, a radius of curvature of the first curved surface is 57×(1±5%) millimeters, and a radius of curvature of the second curved surface is 85×(1±5%) millimeters;
the second lens comprises a third curved surface and a fourth curved surface, a radius of curvature of the third curved surface is 210×(1±5%) millimeters, and a radius of curvature of the fourth curved surface is 37×(1±5%) millimeters;
the third lens comprises a fifth curved surface and a sixth curved surface, a radius of curvature of the fifth curved surface is 100×(1±5%) millimeters, and a radius of curvature of the sixth curved surface is 400×(1±5%) mm;
the first curved surface, the second curved surface, the third curved surface, the fourth curved surface, the fifth curved surface, and the sixth curved surface are successively arranged, and all are convex to the object side.

2. The far infrared lens assembly according to claim 1, wherein a distance between the second curved surface and the third curved surface is 15 millimeters, and a distance between the fourth curved surface and the fifth curved surface is 30 millimeters.

3. The far infrared lens assembly according to claim 1, wherein a central thickness of the first lens is 5×(1±5%) millimeters.

4. The far infrared lens assembly according to claim 1, wherein a central thickness of the second lens is 2×(1±5%) millimeters

5. The far infrared lens assembly according to claim 1, wherein a central thickness of the third lens is 3×(1±5%) millimeters

6. The far infrared lens assembly according to claim 1, wherein the first lens is made of Ge.

7. The far infrared lens assembly according to claim 1, wherein the second lens is made of ZnSe.

8. The far infrared lens assembly according to claim 1, wherein the third lens is made of Ge.

9. A far infrared objective lens, comprising a lens barrel and a lens assembly according to claim 1, wherein the lens barrel is configured to receive the lens assembly.

10. A fire source detector of a fire hazard, comprising a far infrared imaging objective lens according to claim 9 and a thermo-sensitive receiver, wherein the thermo-sensitive receiver is located on a focal point of the objective lens.
